(19) United States
(12) Patent Application Publication
(10) Pub. No.: US 2006/0135710 A1
(43) Pub. Date: Jun. 22, 2006

(54) Epoxy resin compositions, methods of preparing and articles made therefrom

(75) Inventor: C. David Shirrell, Houston, TX (US)

Correspondence Address: RESOLUTION PERFORMANCE PRODUCTS LLC;ATTN: LISA JONES, 1600 SMITH STREET, P.O. BOX 4500, HOUSTON, TX, 77210-4500, US

(73) Assignee: Resolution Performance Products LLC

(21) Appl. No.: 11/015,536

(22) Filed: Dec. 17, 2004

(51) Int. Cl. C08L 63/00; C08G 59/00

(52) U.S. Cl. 525/481; 528/104

(57) ABSTRACT

A phenolic novolac cured epoxy resin system, preferably utilized in electrical laminating applications, producing resins with a favorable balance of properties including relatively low Dₖ values with comparable T_{g} and time to delaminate values. The phenolic novolac curing agent is substituted with alkyl or aryl groups, which may be the same or different. The alkyl group is preferably a C₂-C₂₀ group, more preferably a C₄-C₉ group, and most preferably a butyl or octyl group. The aryl group is preferably a phenyl group. The curing agents of the invention and may be used separately, in combination with each other, or in combination with other curing agents.

### FIELD OF THE INVENTION

The present invention relates to epoxy resin compositions, to methods of preparing these epoxy resin compositions and to articles made therefrom. Specifically, the invention relates to epoxy resin compositions including a substituted novolac curing agent, which have an enhanced balance of properties including dielectric constant “Dk” values and glass transition temperature “Tg” values. The resins are particularly suited to be utilized in the manufacture of composites, and especially prepregs used for the fabrication of composite structures.

### BACKGROUND OF THE INVENTION

Prepregs are generally manufactured by impregnating a thermosettable epoxy resin composition into a porous substrate, such as a glass fiber mat, followed by processing at elevated temperatures to promote a partial cure of the epoxy resin in the mat to a “B-stage.” Laminates, and particularly structural and electrical copper clad laminates, are generally manufactured by pressing, under elevated temperatures and pressures, various layers of partially cured prepregs and optionally copper sheeting. Complete cure of the epoxy resin impregnated in the glass fiber mat typically occurs during the lamination step when the prepreg layers are again pressed under elevated temperatures for a sufficient time.

Epoxy resin systems having a high Tg are desirable in the manufacture of prepregs and laminates. Such systems offer improved heat resistance and reduced thermal expansion required for complex printed circuit board circuitry and for higher fabrication and usage temperatures. Higher Tg values are typically achieved by using multifunctional resins to increase the polymer crosslink density, resins with fused rings to increase polymer background stiffness, or resins with bulky side groups to inhibit molecular rotation about the polymer chains. However, such systems are typically more expensive to formulate and suffer from inferior performance capabilities.

Tg, as used herein, refers to the glass transition temperature of the thermosettable resin system in its current cure state. As the prepreg is exposed to heat, the resin undergoes further cure and its Tg increases, requiring a corresponding increase in the curing temperature to which the prepreg is exposed. The ultimate, or maximum, Tg of the resin is the point at which essentially complete chemical reaction has been achieved. “Essentially complete” reaction of the resin has been achieved when no further reaction exotherm is observed by differential scanning calorimetry (DSC) upon heating of the resin.

Epoxy resin systems having a low Dk and low dissipation factor “Df” are also desirable in the manufacture of prepregs and laminates. Such systems offer improved speed of electronic signal transmission in the laminates, and therefore allow data to be processed at greater speeds required for modern devices.

In light of the above, there is a need in the art for epoxy resin systems having improved properties and for prepregs having enhanced Tg and varnish gel times, for methods of preparing such resin systems and prepregs and for articles prepared therefrom.

### SUMMARY OF THE INVENTION

The epoxy resin composition of the invention includes an epoxy resin component and a curing agent including at least one substituted novolac represented by the general formula:

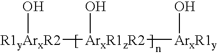

wherein each Ar represents an aryl or cyclo-alkyl group containing x number of carbon atoms, OH represents a hydroxyl group bonded to each Ar group, each R1 represents substituent group(s) bonded to each Ar group and each R1 is an alkyl group or aryl group containing 2 to 20 carbon atoms, each R2 represents a group connecting adjacent Ar groups, n is a number between 2 and 20, x is an integer from 4 to 8, y is an integer from 1 to x-2, and z is an integer from 1 to x-3. Additionally, when cured into a varnish, the epoxy resin composition of the invention has an enhanced balance of properties including a Dk at 1 MHz, of less than 3.5 and a (Df) at 1 MHz, of less than 0.02.

The invention is also directed to a method of preparing the resin composition which includes the step of contacting an epoxy resin with the at least one substituted novolac as described above, and to a prepreg prepared therefrom.

### BRIEF DESCRIPTION OF THE DRAWINGS

FIG. 1 is a plot of Dielectric Constant as a function of Frequency For Example 3 of the invention and Comparative Examples 1 and 2.

FIG. 2 is a plot of Dissipation as a function of Frequency for Example 3 of the invention and Comparative Examples 1 and 2.

### DETAILED DESCRIPTION OF THE INVENTION

The epoxy resin composition of the present invention exhibits a favorable balance of properties and includes at least one epoxy resin component and at least one substituted novolac curing agent. Preferably, the epoxy resin component includes a halogenated epoxy resin or a mixture of an epoxy resin and a flame retarded additive and phenolic hydroxyl groups, wherein the flame retarded additive may or may not contain a halogen.

A. Epoxy Resin Component

The epoxy resin compositions of the invention include at least one epoxy resin component. Epoxy resins are those compounds containing at least one vicinal epoxy group. The epoxy resin may be saturated or unsaturated, aliphatic, cycloaliphatic, aromatic or heterocyclic and may be substituted. The epoxy resin may also be monomeric or polymeric.

The epoxy resin compound utilized may be, for example, an epoxy resin or a combination of epoxy resins prepared from an epihalohydrin and a phenol or a phenol type compound, prepared from an epihalohydrin and an amine, prepared from an epihalohydrin and an a carboxylic acid, or prepared from the oxidation of unsaturated compounds.

In one embodiment, the epoxy resins utilized in the compositions of the present invention include those resins produced from an epihalohydrin and a phenol or a phenol type compound. The phenol type compound includes compounds having an average of more than one aromatic hydroxyl group per molecule. Examples of phenol type compounds include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (i.e. the reaction product of phenols and simple aldehydes, preferably formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins or combinations thereof.

In another embodiment, the epoxy resins utilized in the compositions of the invention preferably include those resins produced from an epihalohydrin and bisphenols, halogenated bisphenols, hydrogenated bisphenols, novolac resins, and polyalkylene glycols or combinations thereof.

In another embodiment, the epoxy resin compounds utilized in the compositions of the invention preferably include those resins produced from an epihalohydrin and resorcinol, catechol, hydroquinone, biphenol, bisphenol A, bisphenol AP (1,1-bis(4-hydroxyphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A or combinations thereof.

In a preferred embodiment, the epoxy resin component includes a halogenated epoxy resin, an in-situ halogenated epoxy resin or a combination thereof. The preferred halogen is bromine. In situ bromination may occur, for example, utilizing in combination an epoxy resin and a brominated phenol, such as for example tetrabrominted bisphenol-A (TBBPA). The amount of bromine in the system is preferably adjusted such that the burn time of a laminate produced, as measured by Underwriter Laboratories test V0, is between about 2 to about 50 seconds, preferably about 10 to about 50 seconds and more preferably about 15 to about 30 seconds. In a more preferred embodiment, the epoxy resin component includes a resin component prepared from an epihalohydrin and a phenol or a phenol type compound utilized in combination with a brominated epoxy resins or an in-situ brominated epoxy resin.

In another embodiment, the epoxy resin component includes a mixture of an epoxy resin and a flame retarded additive and phenolic hydroxyl groups. The flame retardant additive may or may not contain a halogen. Suitable examples of halogenated flame retardant additives include, but are not limited to, tetrabromobisphenol A (TBBPA), epoxidized TBBPA and its oligomers (EPON Resin 1163), tetrachlorobisphenol A (TCBPA), epoxidized TCBPA and its oligomers, brominated and chlorinated novolacs, bromophenol & chlorophenol, dibromophenol & dichlorophenol, 2,4,6-Tribromophenol and 2,4,6-Trichlorophenol, halogenated β-lactones, chlorendic anhydride [1,4,5,6,7,7-hexachlorobicyclo[2.2.1]-5-heptane-2,3-dicarboxylic acid], chlorinated waxes, tetrabromophthalic anhydride, oligomeric brominated polycarbonates and combinations thereof. Suitable examples of nonhalogenated flame retardant additives include, but are not limited to aluminum oxide hydrates, aluminum carbonates, magnesium hydroxides, vitrifying borates and phosphates, red phosphorous, phosphoric acid esters, phosphonic acid esters, phosphines, phosphinates, phosphonates, melamine resins (melamine cyanurates and melamine cyanurates), triphenyl phosphates diphenyl phosphates, polyamine 1,3,5-tris(3-amino-4-alkylphenyl)-2,4,6-trioxohexahydrotriazine, epoxy group containing glycidyl phosphate or glycidyl phosphinate, dihydro-9-oxa-10-phosphapheneantrene-10-oxide and its epoxidized variants, antimony trioxide, zinc borate and combinations thereof.

The preparation of epoxy resin compounds is well known in the art. See Kirk-Othmer, Encyclopedia of Chemical Technology, 3^{rd} Ed., Vol. 9, pp 267-289. Examples of epoxy resins and their precursors suitable for use in the compositions of the invention are also described, for example, in U.S. Pat. Nos. 5,137,990 and 6,451,898 which are incorporated herein by reference.

In another embodiment, the epoxy resins utilized in the compositions of the present invention include those resins produced from an epihalohydrin and an amine. Suitable amines include diaminodiphenylmethane, aminophenol, xylene diamine, anilines, and the like, or combinations thereof.

In another embodiment, the epoxy resin utilized in the compositions of the present invention include those resins produced from an epihalohydrin and a carboxylic acid. Suitable carboxylic acids include phthalic acid, isophthalic acid, terephihalic acid, tetrahydro- and/or hexahydrophthalic acid, endomethylenetetrahydrophthalic acid, isophthalic acid, methylhexahydrophthalic acid, and the like or combinations thereof.

In another embodiment, the epoxy resin compounds utilized in the compositions of the invention include those resins produced from an epihalohydrin and compounds having at least one aliphatic hydroxyl group. In this embodiment, it is understood that such resin compositions produced contain an average of more than one aliphatic hydroxyl groups. Examples of compounds having at least one aliphatic hydroxyl group per molecule include aliphatic alcohols, aliphatic diols, polyether diols, polyether triols, polyether tetrols, any combination thereof and the like. Also suitable are the alkylene oxide adducts of compounds containing at least one aromatic hydroxyl group. In this embodiment, it is understood that such resin compositions produced contain an average of more than one aromatic hydroxyl groups. Examples of oxide adducts of compounds containing at least one aromatic hydroxyl group per molecule include ethylene oxide, propylene oxide, or butylene oxide adducts of dihydroxy phenols, biphenols, bisphenols, halogenated bisphenols, alkylated bisphenols, trisphenols, phenol-aldehyde novolac resins, halogenated phenol-aldehyde novolac resins, alkylated phenol-aldehyde novolac resins, hydrocarbon-phenol resins, hydrocarbon-halogenated phenol resins, or hydrocarbon-alkylated phenol resins, or combinations thereof.

In another embodiment the epoxy resin refers to an advanced epoxy resin which is the reaction product of one or more epoxy resins components, as described above, with one or more phenol type compounds and/or one or more compounds having an average of more than one aliphatic hydroxyl group per molecule as described above. Alternatively, the epoxy resin may be reacted with a carboxyl substituted hydrocarbon. A carboxyl substituted hydrocarbon which is described herein as a compound having a hydrocarbon backbone, preferably a C₁-C₄₀ hydrocarbon backbone, and one or more carboxyl moieties, preferably more than one, and most preferably two. The C₁-C₄₀ hydrocarbon backbone may be a straight- or branched-chain alkane or alkene, optionally containing oxygen. Fatty acids and fatty acid dimers are among the useful carboxylic acid substituted hydrocarbons. Included in the fatty acids are caproic acid, caprylic acid, capric acid, octanoic acid, VERSATIC™ acids, available from Resolution Performance Products LLC, Houston, Tex., decanoic acid, lauric acid, myristic acid, palmitic acid, stearic acid, palmitoleic acid, oleic acid, linoleic acid, linolenic acid, erucic acid, pentadecanoic acid, margaric acid, arachidic acid, and dimers thereof.

In another embodiment, the epoxy resin is the reaction product of a polyepoxide and a compound containing more than one isocyanate moiety or a polyisocyanate. Preferably the epoxy resin produced in such a reaction is an epoxy-terminated polyoxazolidone.

B. Substituted Novolac Curing Agent

The epoxy resin compositions of the invention, having a favorable balance of physical properties, include a substituted novolac curing agent or a blend of differently substituted novolac curing each represented by Formula 1.

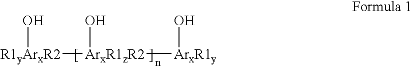

In Formula 1, Ar represents an aryl or cyclo-alkyl group where each Ar group contains x number of carbon atoms, OH represents a hydroxyl group bonded to each Ar group, R1 represents substituent group(s) bonded to each Ar group, each R2 represents a group connecting adjacent Ar groups, n is a number between 2 and 20, x is an integer from 4 to 8, y is an integer from 1 to x-2, and z is an integer from 1 to x-3.

Preferably, in Formula 1, each Ar may be the same or different and contains 5 to 7 carbon atoms and more preferably contains 6 carbon atoms; each R1 may be the same or different and is an alkyl group or aryl group containing 2 to 20 carbon atoms, more preferably containing 4 to 9 carbon atoms and most preferably selected from a butyl, octyl or phenyl group; each R2 may be the same or different and is an alkyl group, more preferably an alkyl group containing 1 to 5 carbon atoms, and most preferably a methyl or ethyl group; n is a number from 2 and 20 and preferably from 4 and 20.

In a preferred embodiment, the epoxy compositions of the invention contain a substituted novolac curing agent or a blend of differently substituted novolac curing agents each represented by Formula 2.

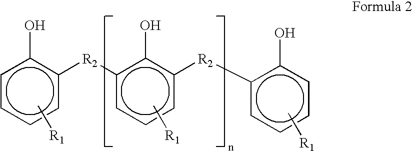

In Formula 2, R1, R2 and n are defined as above in Formula 1. In a more preferred embodiment, R1 represents a single alkyl substituent in the para position having from 4 to 9 carbon atoms and is most preferably a butyl or octyl group.

In another preferred embodiment, the epoxy compositions of the invention contain a substituted novolac curing agent or a blend of differently substituted novolac curing agents each represented by Formula 3. 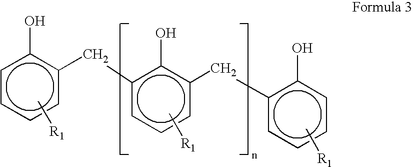
In Formula 3, R1 and n are defined as above.

In another embodiment, the substituted novolac curing agent is selected from octyl-phenol novolac, nonyl-phenol novolac, phenyl phenol novolac, t-butyl-phenol novolac and combinations thereof. In a preferred embodiment the curing agent comprises a combination of octyl phenol novolac and butyl novolac.

In another embodiment, the substituted novolac curing agent comprises a co-novolac compound represented by any of Formulae 1, 2 or 3, wherein R1 represents a different alkyl groups on the same molecule. In this embodiment each R1 is preferably an alkyl group, having from 4 to 9 carbon atoms, and is more preferably a butyl or octyl group. In a preferred embodiment, the curing agents comprises a co-novolac containing octyl and butyl substituent groups.

In another embodiment, and in addition to the above, the substituted novolac curing agent comprises a compound represented by any of Formulae 1, 2 or 3 wherein the weight average molecular weight (M_{w}) of the substituted novolac curing agent is less than 4000, preferably less than 3000, preferably between about 1000 and 4000, more preferably between about 1500 and 3000, and even more preferably between about 1600 to 2700.

In another embodiment, the substituted novolac curing agent of the invention is utilized in combination with other curing agents known in the art such as for example, with unsubstituted phenol curing agents, or an amine- or amide-containing curing agent. Suitable unsubstituted phenol curing agents include include dihydroxy phenols, biphenols, bisphenols, halogenated biphenols, halogenated bisphenols, hydrogenated bisphenols, trisphenols, phenol-aldehyde resins, phenol-aldehyde novolac resins, halogenated phenol-aldehyde novolac resins, phenol-hydrocarbon resins, phenol-hydroxybenzaldehyde resins, alkylated phenol-hydroxybenzaldehyde resins, hydrocarbon-phenol resins, hydrocarbon-halogenated phenol resins, or combinations thereof. Preferably, the unsubstituted phenolic curing agent includes unsubstituted phenols, biphenols, bisphenols, novolacs or combinations thereof.

The ratio of curing agent to epoxy resin is preferably suitable to provide a fully cured resin. The amount of curing agent which may be present may vary depending upon the particular curing agent used (due to the cure chemistry and curing agent equivalent weight as is well known in the art). In one embodiment, the ratio of total epoxy groups to the phenolic hydroxyl equivalents is between about 0.5 to about 1.5, preferably between about 0.6 to about 1.2, and more preferably between about 0.8 to about 1.0.

C. Accelerators

Accelerators useful in the compositions of the invention include those compounds which catalyze the reaction of the epoxy resin with the curing agent.

In one embodiment, the accelerators are compounds containing amine, phosphine, heterocyclic nitrogen, ammonium, phosphonium, arsonium or sulfonium moieties. More preferably, the accelerators are heterocyclic nitrogen and amine-containing compounds and even more preferably, the accelerators are heterocyclic nitrogen-containing compounds.

In another embodiment, the heterocyclic nitrogen-containing compounds useful as accelerators include heterocyclic secondary and tertiary amines or nitrogen-containing compounds such as, for example, imidazoles, imidazolidines, imidazolines, bicyclic amidines, oxazoles, thiazoles, pyridines, pyrazines, morpholines, pyridazines, pyrimidines, pyrrolidines, pyrazoles, quinoxalines, quinazolines, phthalazines, quinolines, purines, indazoles, indazolines, phenazines, phenarsazines, phenothiazines, pyrrolines, indolines, piperidines, piperazines, as well as quaternary ammonium, phosphonium, arsonium or stibonium, tertiary sulfonium, secondary iodonium, and other related “onium” salts or bases, tertiary phosphines, amine oxides, and combinations thereof. Imidazoles as utilized herein include imidazole, 1-methylimidazole, 2-methylimidazole, 4-methylimidazole, 2-ethylimidazole, 2-ethyl4-methylimidazole, 2-phenylimidazole, 2-undecylimidazole, 1-benzyl-2-methylimidazole, 2-heptadecyl imidazole, 4,5-diphenylimidazole, 2-isopropylimidazole, 2,4-dimethyl imidazole, 2-phenyl-4-methylimidazole, 1-cyanoethyl-2-ethyl-4-methylimidazole and the like. Preferred imidazoles include 2-methylimidazole, 2-phenylimidazole and 2-ethyl-4-methylimidazole.

Imidazolines as utilized herein include 2-methyl-2-imidazoline, 2-phenyl-2-imidazoline, 2-undecylimidazoline, 2-heptadecylimidazoline, 2-isopropylimidazole, 2,4-dimethylimidazoline, 2-phenyl-4-methylimidazoline, 2-ethylimidazoline, 2-isopropylimidazoline, 4,4-dimethyl-2-imidazoline, 2-benzyl-2-imidazoline, 2-phenyl-4-methylimidazoline and the like.

Among preferred tertiary amines that may be used as accelerators are those mono- or polyamines having an open chain or cyclic structure which have all of the amine hydrogen replaced by suitable substituents, such as hydrocarbon radicals, and preferably aliphatic, cycloaliphatic or aromatic radicals. Examples of these amines include, among others, methyl diethanolamine, triethylamine, tributylamine, benzyl-dimethylamine, tricyclohexyl amine, pyridine, quinoline, and the like. Preferred amines are the trialkyl and tricycloalkyl amines, such as triethylamine, tri(2,3-dimethylcyclohexyl)amine, and the alkyl dialkanol amines, such as methyl diethanolamine and the trialkanolamines such as triethanolamine. Weak tertiary amines, e.g., amines that in aqueous solutions give a pH less than 10, are particularly preferred. Especially preferred tertiary amine accelerators are benzyldimethylamine and tris-(dimethylaminomethyl) phenol.

The amount of accelerator present may vary depending upon the particular curing agent used (due to the cure chemistry and curing agent equivalent weight as is known in the art).

D. Resin Compositions

In one embodiment the epoxy resin composition includes an epoxy resin component, at least one substituted novolac curing agent or a combination of differently substituted novolac curing agents each represented by any of Formulae 1, 2 or 3 above, and optionally an accelerator. In one embodiment, the epoxy resin component contains an epoxy resin produced from an epihalohydrin and a phenol or a phenol type compound and a halogenated epoxy resin produced from an epihaloydrin and a halogenated phenol or phenol type compound, In another embodiment, the epoxy resin component includes a mixture of an epoxy resin and a flame retarded additive and phenolic hydroxyl groups, wherein the flame retarded additive may or may not contain a halogen.

In a preferred embodiment, the epoxy resin compositions includes an epoxy resin component, a halogenated epoxy resin component, and a curing agent including at least two differently substituted novolac compounds each represented by any of Formulae 1, 2 or 3 above, and optionally an accelerator. Preferably, the two differently substituted novolac compounds are each represented by any of Formulae 1, 2 or 3 above wherein R1 is an alkyl group, having from 4 to 9 carbon atoms and more preferably each R1 a butyl or octyl group. More preferably, the curing agent includes octyl phenyl novolac (OPN) and butyl phenyl novolac (BPN) wherein the weight ratio of OPN:BPN, based on the combined weight of OPN and BPN, is about 0:100 to about 100:0, preferably is about 10:90 to about 90:10, and more preferably about 25:75 to about 75:25.

In a more preferred embodiment, the epoxy resin composition includes and epoxy resin component and a curing agent including a co-novolac compound represented by any of Formulae 1, 2 or 3, wherein R1 represents a different alkyl groups on the same molecule. In this embodiment each R1 is preferably an alkyl group, having from 4 to 9 carbon atoms, and is more preferably a butyl or octyl group.

In another embodiment, and in addition to the above, the Tg of the fully cured resin composition, as measured by measured by Differential Scanning Calorimetry (DSC), is greater than 140° C., preferably greater than 150° C. and more preferably between about 145° C. and about 170° C.

In another embodiment, and in addition to the above, the copper peel (Cu peel) is greater than 5 lbs/inch, preferably greater than 8 lbs/inch.

In another embodiment, and in addition to the above, the time to delaminate at 260° C., as measured by IPC Test Method IPC-TM-650 2.4.24.1, is greater than 20 minutes, preferably greater than 30 minutes and more preferably greater than 40 minutes. In another embodiment, the time to delaminate at 260° C. is between 20 and 80 minutes.

In one embodiment, and in addition to the above, the D_{f}, as determined in accordance with ASTM D150, at 1 MHz, is less than 0.025, preferably less than 0.02, preferably less than 0.01, more preferably less than 0.001 and even more preferably between about 0.0001 and about 0.03.

In another embodiment, and in addition to the above, the Dₖ, as determined in accordance with ASTM D150, at 1 MHz is less than 3.5 and is preferably between about 2.8 and about 3.3.

The resin compositions of the invention will typically optionally include one or more solvent(s). The concentration of solids in the solvent is at least about 20% by weight, preferably about 20% to about 90% by weight, more preferably about 50% to about 80% by weight. Suitable solvents include ketones, alcohols, glycol ethers, aromatic hydrocarbons and mixtures thereof. Preferred solvents include methyl ethyl ketone, methyl isobutyl ketone, propylene glycol methyl ether, ethylene glycol methyl ether, methyl amyl ketone, methanol, isopropanol, toluene, xylene, dimethylformamide and the like. A single solvent may be used, but in many applications a separate solvent is used for each component. Preferred solvents for the epoxy resins are ketones, including acetone, methylethyl ketone and the like. Preferred solvents for the curing agents include, for example ketones, amides such as dimethylformamide (DMF), ether alcohols such as methyl, ethyl, propyl or butyl ethers of ethylene glycol, diethylene glycol, propylene glycol or dipropylene glycol, ethylene glycol monomethyl ether, or 1-methoxy-2-propanol.

The resin compositions of the invention may also include optional constituents such as inorganic fillers and additional flame retardants, for example antimony oxide, octabromodiphenyl oxide, decabromodiphenyl oxide, and other such constituents as is known in the art including, but not limited to, dyes, pigments, surfactants, flow control agents and the like.

The compositions of the invention may be impregnated upon a reinforcing material to make laminates, such as electrical laminates as is known in the art. The reinforcing materials which may be coated with the compositions of this invention include any material which would be used by the skilled artisan in formation of composites, prepregs, laminates and the like. Examples of appropriate substrates include fiber-containing materials such as woven cloth, mesh, mat, fibers, or the like. Preferably, such materials are made from glass or fiberglass, quartz, paper, polyethylene, poly(p-phenylene-terephthalamide), polyester, polytetrafluoroethylene, poly(p-phenylenebenzo-bisthiazole), carbon or graphite and the like. Preferred materials include glass or fiberglass, in woven cloth or mat form.

Compositions containing the epoxy resins compositions of the invention may be contacted with an article used in any method known to those skilled in the art. Examples of such contacting methods include powder coating, spray coating, die coating, roll coating and contacting the article with a bath containing the composition. In a preferred embodiment the article is contacted with the composition in a bath.

In addition to high-performance electrical laminates, the resin compositions of the invention are useful for molding powders, coatings, and structural composite parts fabrication.

The epoxy resin compositions described herein may be found in various forms. In particular, the various compositions described may be found in powder form, hot melt, or alternatively in solution or dispersion. In those embodiments where the various compositions are in solution or dispersion, the various components of the composition may be dissolved or dispersed in the same solvent or may be separately dissolved in a solvent suitable for that component, then the various solutions are combined and mixed. In those embodiments wherein the compositions are partially cured or advanced, the compositions of this invention may be found in a powder form, solution form, or coated on a particular substrate.

In order to provide a better understanding of the present invention including representative advantages thereof, the following examples are offered. However, this invention is by no means limited by these examples.

### EXAMPLES

The characteristic properties referred to in these examples were measured according to the methods listed below.

Dielectric Constant (Dₖ)—For frequencies at or below 10 megahertz (MHz), this measurement was conducted per ASTM (American Society for Testing and Materials) D150, “Standard Test Method for A-C Loss Characteristics and Permittivity (Dielectric Constant) of Solid Electrical Insulating Materials”. A parallel-plate fixture having a 1.5 inch diameter guided electrode was utilized to conduct these tests. For frequencies above 10 MHz, this measurement was conducted per ASTM D2520, “Standard Test Methods for Complex Permittivity (Dielectric Constant) of Solids Electrical Insulating Materials at Microwave Frequencies and Temperatures to 1650 Degrees C.”. Method B, Resonant Cavity Perturbation Technique, was used. The electrical field inside the cavities was parallel to the length of the test samples. The precision of the results was typically ±1%.

Dissipation Factor (D_{f})—For frequencies at or below 10 megahertz (MHz), this measurement was conducted per ASTM D150, “Standard Test Method for A-C Loss Characteristics and Permittivity (Dielectric Constant) of Solid Electrical Insulating Materials”. A parallel-plate fixture having a 1.5 inch diameter guided electrode was utilized to conduct these tests. For frequencies above 10 MHz, this measurement was conducted per ASTM D2520, “Standard Test Methods for Complex Permittivity (Dielectric Constant) of Solids Electrical Insulating Materials at Microwave Frequencies and Temperatures to 1650 Degrees C.”. Method B, Resonant Cavity Perturbation Technique, was used. The electrical field inside the cavities was parallel to the length of the test samples. The precision of the results was typically ±2 to 3%.

Glass Transition Temperature—The Glass Transition Temperature (Tg) of the resin in the laminates was measured by Differential Scanning Calorimetry (DSC) at a heat-up rate of 20° C./minute from 50° C. to 220° C. followed by rapid cooling and a second identical heating rate scan. The Temperature of the DSC was calibrated using an Indium and a Tin standard. The DSC instrument was a Perkin Elmer DSC Model 7.

Molecular Weight via Gel Permeation Chromatography—The Weight Average Molecular Weight (Mw) herein is measured uses size exclusion gel permeation chromatography (GPC) which was calibrated using polystyrene molecular weight standards. A sample is dissolved in tetrahydrofuran and the resulting solution is run through a Hewlett Packard model 1100HPLC.

Prepreg Dust Gel Time—Approximately 0.2 grams of prepreg dust is placed upon the preheated (348° F.) surface of a hot plate that had been treated with a mold release agent. After 10 seconds, to allow the prepreg dust to melt, the mixture was repeatedly stroked to the left and to the right using a 0.5 inch wide preheated stainless steel spatula having a wooden handle. With time, the mixture begins to polymerize and becomes a viscous stringy mass. Eventually, these strings no longer form between the gel plate and the spatula during the stroking process. The time from when the sample was placed upon the gel plate unto when this stringing ceases is considered as the Prepreg Dust Gel Time and it is recorded in seconds. This test was conducted in duplicate.

Prepreg Volatile Content—A 10.2 cm×10.2 cm piece of prepreg is conditioned at 50% Relative Humidity and 25° C. for four hours. It is then weighed to the nearest milligram (W₁). The prepreg is hung from a metal hook in a preheated oven at 163° C. for 15 minutes. It is the allowed to cool in a dessicator. The prepreg is then weighed to the nearest milligram (W₂). The volatile content of the prepreg is calculated as follows:
Volatile Content, wt %=((W₁−W₂)×100)/W₁

Resin Content—The Resin Content of the prepreg was measured using the procedures in IPC (Institute for Interconnecting and Packing Electronic Circuits) Test Method IPC-TM-650 2.3.16.2, “treated Weight of Prepreg”.

Resin Flow—The Resin Flow of the prepreg was measured using the procedures in IPC Test Method IPC-TM-650 2.3.17, “Resin Flow Percent of Prepreg”.

Time to Delamination at Temperature—This test was conducted using the procedures in IPC Test Method IPC-TM-650 2.4.24.1, “Time to Delamination (TMA Method)”.

Total Burn Time—This test was conducted per IPC Test Method IPC-TM-650 2.3.10, “Flammability of Laminate”. The Total Burn Time is the sum of the first and second burn times of five samples. No Individual burn time was greater than 10 seconds.

Varnish Gel Time—Three milliliters of an epoxy varnish formulation were placed on the surface of a preheated (348° F.) hot plate that had been treated with a mold release agent. After 15 seconds, to allow the majority of the organic solvent(s) to evaporate, the mixture was repeatedly stroked to the left and to the right using a 0.5 inch wide preheated stainless steel spatula having a wooden handle. With time, the mixture begins to polymerize and becomes a viscous stringy mass. Eventually, these strings no longer form between the gel plate and the spatula during the stroking process. The time from when the sample was placed upon the gel plate unto when this stringing ceases is considered as the Varnish Gel Time and it is recorded in seconds.

Weight per Epoxide—The weight per Epoxide (WPE & also known as the epoxy equivalent weight, EEW) was measured using an industry standard perchloric acid titration method.

### Comparative Example 1

A varnish composition was prepared from its components according to Table 1. A Brominated Bisphenol of Acetone epoxy resin (having a weight per Epoxide, WPE, from 428 to 442 grams per equivalent; containing 18.2 to 20.5 weight percent Bromine, solids basis; and, dissolved in Acetone at 79.5 to 80.5 weight percent solids available from Resolution Performance Products as EPON® Resin 1124-A-80) was combined first with a solution composed of 7 weight percent Dicyandiamide (DICY) dissolved in 93 weight percent Ethylene Glycol Monomethyl Ether (MeOX) and then combined with a solution composed of 10 weight percent 2-Methyl Imidazole (2MI) dissolved in 90 weight percent MeOX. This mixture was thoroughly stirred until homogenous. The gel time of this reactive varnish mixture was determined to be 117 seconds (at 171° C.).

This varnish was used to impregnate 33 cm×33 cm pieces of woven glass cloth (glass cloth style 7628 with glass binder type 643 available from BGF Industries Inc.). This material is an industrial grade fiberglass cloth commonly utilized in the electrical laminating industry.

A pre-measured quantity of the varnish solution was applied to the fiberglass cloth manually and the varnish was uniformly distributed and worked into the fiberglass cloth using a paintbrush. The resulting varnish impregnated fiberglass cloth was hung in an air-circulating oven at 165° C. to remove its volatile solvents and to partially cure the varnish's reactive components. Each sheet of prepreg was kept in the air-circulating oven for 2.75 minutes. After allowing the prepreg to cool to room temperature, the partially cured resin in each prepreg sheet was subjected to mechanical abrasion to physically remove it from the fiberglass cloth. Any remaining glass fibers in this prepreg dust were then separated from the partially cured resin dust. A selected amount of this prepreg dust was placed into a rectangular cavity mold and it was inserted between temperature controlled platens of a laboratory press (Tetrahedron Associates, Incorporated, model 1402). The polymerization of the neat resin prepreg dust was completed using the following cure cycle:
(1) apply 0.64 MPa pressure to the mold;
(2) increase the temperature of the mold from room temperature to 182.2° C. at 5.6° C. per minute; upon reaching 182.2° C., hold at this temperature for 1 hour;
(3) cool under pressure from 182.2° C. to 40.6° C. at 5.6° C. per minute; and,
(4) release the pressure and remove the cured neat resin casting from the mold.

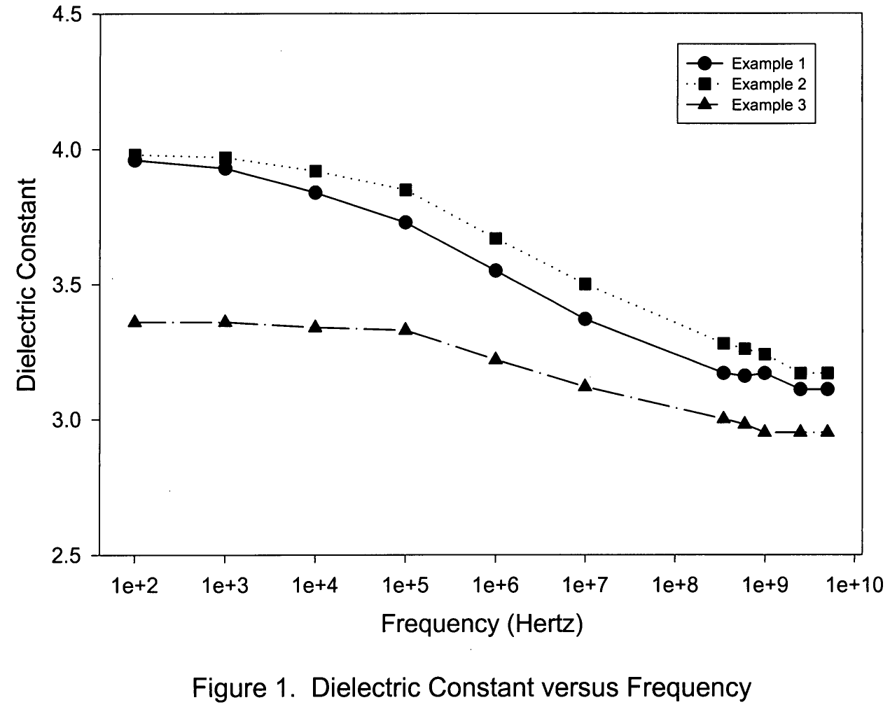

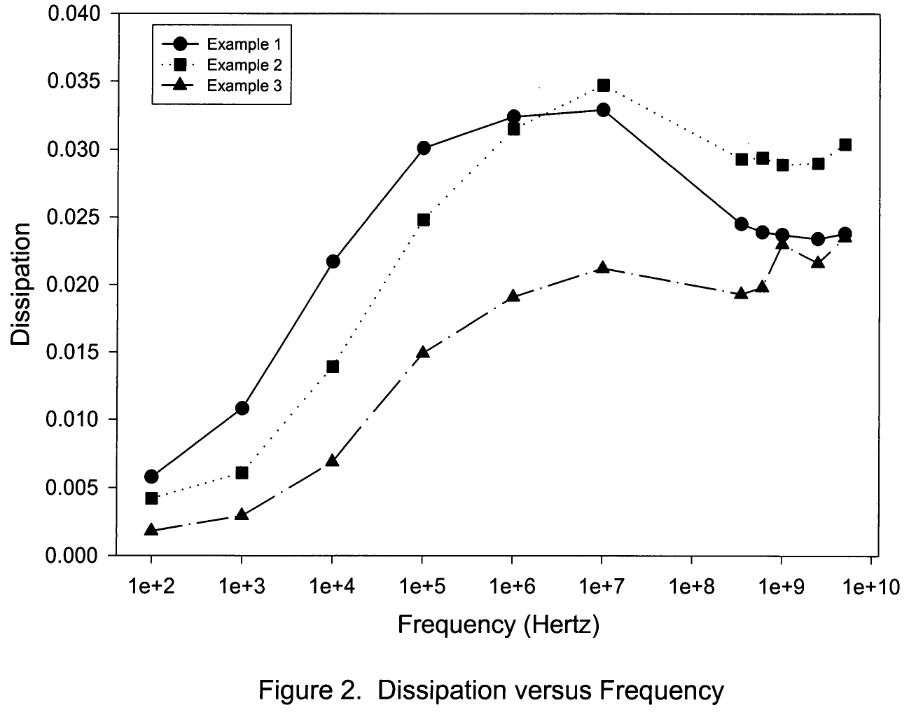

The dielectric constant and dissipation of this neat casting was then measured at room temperature using the methods described earlier in this section. These measured values can be found in Table 2 and FIGS. 1 and 2.

### Comparative Example 2

The varnish composition of Example 2 was prepared from its components according to Table 1 and the procedures described in Example 1. The varnish was prepared using an epoxidized phenolic novolac resin dissolved in Acetone (having a WPE of 176 to 181 available from Resolution Performance Products as EPON Resin 154. This solution was 80% by weight EPON Resin 154 and 20% by weight Acetone.), an epoxidized multifunctional resin (having a WPE of 200 to 240 available from Resolution Performance Products as EPON Resin 1031), and a Diglycidyl ether from epichlorohydrin and Tetrabromobisphenol of Acetone (having a WPE from 380 to 410 and containing 50 weight percent Bromine available from Resolution Performance Products as EPON Resin 1163). To this resin mixture was added a phenolic novolac (with a Weight Average Molecular Weight, M_{w} of 1610 and residual monomer content of less than 1.0 weight percent available from Borden Chemical Company as SD-1702). The phenolic novolac was allowed to completely dissolve, at ambient temperature with mechanical agitation, into the resin solution. A solution of 10 weight percent 2MI and 90 weight percent 1-Methoxy-2-propanol (Propylene Glycol Monomethyl Ether, PGME) was then added into the previously made resin solution. The gel time of this reactive varnish was 191 seconds. Each sheet of prepreg was kept in the air-circulating oven for 3:00 minutes. The measured dielectric constant and dissipation of neat resin castings of this formulation can be found in Table 2 and FIGS. 1 and 2.

### Example 3

The varnish composition of Example 3 was prepared from its components according to Table 1 and the procedures described in Examples 1 and 2. The varnish was prepared using an EPON Resin 154/Acetone solution (This solution was 80% by weight EPON Resin 154 and 20% by weight Acetone.) and EPON Resin 1163. To this homogenous resin solution was added a tertiary-butyl phenol novolac (with a Weight Average Molecular Weight, M_{w}, of 1225 and a residual monomer content of less than 4 weight percent), Acetone and PGME. The novolac was allowed to completely dissolve into the resin solution. The gel time of this varnish solution was 185 seconds at 171° C. Each sheet of prepreg was kept in the air-circulating oven for 4.17 minutes. The measured dielectric constant and dissipation of neat resin castings of this formulation can be found in Table 2 and FIGS. 1 and 2.

TABLE 1

| | Example Number | | |
|---|---|---|---|
| | 1 | 2 | 3 |
| parts (grams) EPON Resin 1124-A-80 | 303.70 | — | — |
| parts (grams) EPON Resin 1031 | — | 14.32 | — |
| parts (grams) EPON Resin 154-A-80 | — | 53.96 | 101.70 |
| parts (grams) EPON Resin 1163 | — | 43.15 | 112.98 |
| parts (grams) Phenolic Novolac | — | 39.47 | — |
| (Mw = 1601) | | | |
| parts (grams) t-Butyl Phenol Novolac | — | — | 119.61 |
| (Mw = 1225) | | | |
| parts (grams) Acetone | — | 29.21 | 80.93 |
| parts (grams) PGME | — | 17.11 | 22.48 |
| parts (grams) 7% DICY/93% MeOX | 100.53 | — | — |
| parts (grams) 10% 2MI/90% MeOX | 2.70 | — | — |
| parts (grams) 10% 2MI/90% PGME | — | 0.71 | 12.56 |

TABLE 2

| | Example Number | | | | | |
|---|---|---|---|---|---|---|
| Frequency | 1 | | 2 | | 3 | |
| (Hertz) | Dₖ | D_{f} | Dₖ | D_{f} | Dₖ | D_{f} |
| 100 | 3.96 | 0.0058 | 3.98 | 0.0042 | 3.36 | 0.00180 |
| 1000 | 3.93 | 0.0108 | 3.97 | 0.0061 | 3.36 | 0.00294 |
| 10000 | 3.84 | 0.0217 | 3.92 | 0.0139 | 3.34 | 0.0069 |
| 100000 | 3.73 | 0.0301 | 3.85 | 0.0248 | 3.33 | 0.0149 |
| 1000000 | 3.55 | 0.0324 | 3.67 | 0.0315 | 3.22 | 0.0191 |
| 10000000 | 3.37 | 0.0329 | 3.50 | 0.0347 | 3.12 | 0.0212 |
| 350000000 | 3.17 | 0.0245 | 3.28 | 0.0293 | 3.00 | 0.0193 |
| 600000000 | 3.16 | 0.0239 | 3.26 | 0.0294 | 2.98 | 0.0198 |
| 1000000000 | 3.17 | 0.0237 | 3.24 | 0.0289 | 2.95 | 0.0230 |
| 2500000000 | 3.11 | 0.0234 | 3.17 | 0.0290 | 2.95 | 0.0216 |
| 5000000000 | 3.11 | 0.0238 | 3.17 | 0.0304 | 2.95 | 0.0235 |

### Example 4

A varnish composition was prepared from the components according to Table 3. A Diglycidyl ether from epichlorohydrin and Bisphenol of Acetone (having a Weight per Epoxide, WPE, from 185 to 192 grams per equivalent, available from Resolution Performance Products as EPON Resin 828) and EPON Resin 1163 were combined with Acetone and PGME and allowed to dissolve, with mechanical agitation, over several hours at ambient temperature, in a glass vessel. To this homogenous solution was added para-tertiary-methylbutylphenol novolac (commonly referred to as Octylphenol novolac, OPN, with a Weight Average Molecular Weight, Mw, of 2493 and residual monomer content of less than 4 weight percent). The OPN was allowed to completely dissolve, at ambient temperature with mechanical agitation, into the previously made resin solution.

A 10 weight percent 2MI/90 weight percent PGME solution was then added to the above mentioned resin/Novolac solution with mechanical agitation until completely homogenous. The gel time of this reactive varnish solution was measured and incremental amounts of the 10% 2MI/90% PGME solution were added to it until a varnish gel time in the range of 180 to 230 seconds was obtained.

The resulting reactive varnish was use to impregnate 33 cm×33 cm pieces of woven cloth (glass fabric style 7628 with glass binder type 643 available from BGF Industries. Inc.). A premeasured quantity of the varnish solution was applied to the fiberglass cloth manually and the varnish was uniformly distributed and worked into the fiberglass cloth using a paint brush. The resulting varnish impregnated fiberglass cloth was hung in an air circulating oven at 165° C. to remove its volatile solvents and to partially cure the varnish's reactive components. This sheet of prepreg was left in the air circulating oven for a sufficient period of time to provide prepregs with both a low volatile content and an appropriate degree of partial polymerization. These prepregs subsequently yielded fully cured laminates of acceptable resin content and consolidation upon competition of their cure as described below.

Small areas of some of these prepregs were subjected to mechanical abrasion to physically remove the partially cured resin from their woven glass cloth substrate. Any remaining glass fibers in this prepreg dust were then removed and a prepreg dust gel test was conducted in duplicate for each of these samples. The prepreg dust gel time was reported as the average of these two measured values. The typical characteristics of the prepregs were in the following range, depending upon their length of time in the oven:

| Prepreg resin gel time at 175° C. | 55-120 seconds |
|---|---|
| Resin flow at 177° C. | 10-20% |
| Volatile Content | <1% |
| Resin Content | 38-45% |

The prepregs were then fabricated into “FR4” type electrical laminates by placing 8 piles of these prepregs between two sheets of a release fabric (TEDLAR®, 0.00254 cm thickness, available from E.I. du Pont de Nemours and Company) and between two 0.635 cm thick Aluminum pressing plates. This entire assemble was subsequently inserted between temperature controlled platens of a laboratory press (Tetrahedron Associates, Incorporated, model 1402) and cured using the following press cycle:
(1) apply 0.64 MPa pressure to the mold and increase its temperature from ambient to 177° C. at 5.6° C./minute;
(2) when a temperature of 177° C. is obtained, hold at this temperature and 0.64 MPa pressure for one hour; and,
(3) then decrease the temperature from 177° C. to 43° C. at 11.2° C./minute; when a temperature of 43° C. is reached, hold at this temperature for two minutes and release the pressure.

The laminates were then trimmed of their edge resin flash and a small, approximately 28 milligrams, test piece was cut from their central area. The Glass Transition of this test piece was measured and it is reported in Table 4. The phenolic hydroxyl to epoxy equivalent ratio in this example was 1.2:1.0.

### Example 5

The varnish composition of Example 5 was prepared from its components according to Table 3 and the procedures described in Example 4. Prepregs and a laminate sample were also prepared as described in Example 4 and Table 4. The phenolic hydroxyl to epoxy equivalent ratio in this example was 1.0:1.0.

### Example 6

The varnish composition of Example 6 was prepared from its components according to Table 3 and the procedures described in Example 4. Prepregs and a laminate sample were also prepared as described in Example 4 and Table 4. The phenolic hydroxyl to epoxy equivalent ratio in this example was 0.8:1.0.

### Example 7

The varnish composition of Example 7 was prepared from its components according to Table 3 and the procedures described in Example 4. Prepregs and a laminate sample were also prepared as described in Example 4 and Table 4. The phenolic hydroxyl to epoxy equivalent ratio in this example was 0.6:1.0.

TABLE 3

| | Example Number | | | |
|---|---|---|---|---|
| | 4 | 5 | 6 | 7 |
| parts (grams) EPON Resin 828 | 14.96 | 18.73 | 31.15 | 29.19 |
| parts (grams) EPON Resin 1163 | 41.97 | 41.94 | 55.97 | 41.96 |
| parts (grams) OPN (Mw = 2493) | 47.94 | 44.21 | 52.79 | 33.72 |
| parts (grams) Acetone | 30.01 | 30.03 | 40.00 | 30.00 |
| parts (grams) PGME | 13.69 | 13.66 | 18.20 | 13.67 |
| parts (grams) 10% 2MI/90% PGME | 8.50 | 8.11 | 8.30 | 7.50 |
| ratio phenolic/epoxy equivalents | 1.2:1 | 1:1 | 0.8:1 | 0.6:1 |

TABLE 4

| | Example Number | | | |
|---|---|---|---|---|
| | 4 | 5 | 6 | 7 |
| Varnish gel time (seconds) | 201 | 182 | 195 | 185 |
| Oven time (minutes) | 3:30 | 4:00 | 4:30 | 3:15 |
| Prepreg resin content (wt %) | 44 | 45 | 45 | 43 |
| Prepreg dust gel time (seconds) | 78 | 55 | 55 | 58 |
| Tg (heat1/heat2) (° C.) | —/165 | 167/166 | 165/165 | 165/166 |

### Example 8

The varnish composition of Example 8 was prepared from its components according to Table 5 and the procedure described in Example 4. Glycidyl ether of a phenolic novolac (having a WPE from 176 to 181 grams per equivalent, available from Resolution Performance Products as EPON Resin 154) was used instead of the Diglycidyl ether of Bisphenol of Acetone in Examples 4 through 7. Prepregs and laminates were subsequently prepared from this varnish as described in Example 4 and Table 6.

### Example 9

The varnish composition of Example 9 was prepared from its components according to Table 5 and the procedures described in Example 4. A Glycidyl ether from epichlorohydrin and an ortho cresol novolac (having a WPE from 200 to 240 grams per equivalent, available from Resolution Performance Products as EPON Resin 164) was used instead of the Diglycidyl ether of Bisphenol of Acetone in Examples 4 through 7. Prepregs and laminates were subsequently prepared from this varnish as described in Example 4 and Table 6.

### Example 10

The varnish composition of Example 10 was prepared from its components according to Table 5 and the procedures described in Example 4. A Glycidyl ether from epichlorohydrin and a Bisphenol of Acetone novolac with an average functionality of eight (having a WPE from 195 to 230 grams per equivalent, available from Resolution Performance Products as EPON Resin SU-8) was used instead of the Diglycidyl ether of Bisphenol of Acetone in Examples 4 through 7. Prepregs and laminates were subsequently prepared from this varnish as described in Example 4 and Table 6.

### Example 11

The varnish composition of Example 11 was prepared from its components according to Table 5 and the procedures described in Example 4. The only epoxy resin used in this formulation was EPON Resin 1163. Prepregs and laminates were subsequently prepared from this varnish as described in Example 4 and Table 6.

TABLE 5

| | Example Number | | | |
|---|---|---|---|---|
| | 8 | 9 | 10 | 11 |
| parts (grams) EPON Resin 155 | 23.38 | — | — | — |
| Parts (grams) EPON Resin164 | — | 13.19 | — | — |
| parts (grams) EPON Resin SU-8 | — | — | 18.89 | — |
| parts (grams) EPON Resin 1163 | 53.52 | 26.76 | 39.01 | 86.62 |
| parts (grams) OPN | 56.90 | 26.95 | 39.50 | 47.17 |
| parts (grams) Acetone | 44.00 | 22.02 | 37.50 | 46.00 |
| parts (grams) PGME | 20.20 | 10.09 | 13.65 | 18.21 |
| parts (grams) 10% 2MI/90% PGME | 7.00 | 4.18 | 3.67 | 12.01 |
| ratio phenolic/epoxy equivalents | 1:1 | 1:1 | 1:1 | 1:1 |

TABLE 6

| | Example Number | | | |
|---|---|---|---|---|
| | 8 | 9 | 10 | 11 |
| Varnish gel time (seconds) | 201 | 203 | 201 | 218 |
| Oven time (minutes) | 3:30 | 4:15 | 4:30 | 4:30 |
| Prepreg resin content (wt %) | 45 | 42 | 42 | 44 |
| Prepreg dust gel time (seconds) | 83 | 69 | 71 | 94 |
| Tg (heat1/heat2) (° C.) | 167/166 | 173/171 | 170/169 | 165/165 |

### Example 12

The varnish composition of Example 12 was prepared from its components according to Table 7 and the procedures described in Example 4. A para-tertiary-butylphenol novolac (tBPN, with a Mw value of 1715 and a residual monomer content of less than 4 weight percent) was used instead of the OPN in Examples 4 through 7. Prepregs and laminates were subsequently prepared from this varnish as described in Example 4 and Table 7.

### Example 13

The varnish composition of Example 13 was prepared from its components according to Table 7 and the procedures described in Example 4. A para-nonylphenol phenol novolac (NPN, with a Mw value of 2752 and a residual monomer content of less than 4 weight percent) was used instead of the OPN in Examples 4 through 7. Prepregs and laminates were subsequently prepared from this varnish as described in Example 4 and Table 8.

### Example 14

The varnish composition of Example 14 was prepared from its components according to Table 7 and the procedures described in Example 4. A para-phenylphenol novolac (PPN, with a Mw value of 1068 and a residual monomer content of less than 4 weight percent) was used instead of the OPN in Examples 4 through 7. Prepregs and laminates were subsequently prepared from this varnish as described in Example 4 and Table 8.

TABLE 7

| | Example Number | | |
|---|---|---|---|
| | 12 | 13 | 14 |
| parts (grams) EPON Resin SU8 | 16.61 | 19.22 | 17.88 |
| parts (grams) EPON Resin 1163 | 26.37 | 33.61 | 27.99 |
| parts (grams) tBPN | 22.94 | — | — |
| parts (grams) NPN | — | 31.18 | — |
| parts (grams) PPN | — | — | 24.06 |
| parts (grams) Acetone | 22.00 | 29.78 | 23.34 |
| parts (grams) PGME | 10.12 | 11.23 | 10.79 |
| parts (grams) 10% 2MI/90% PGME | 2.00 | 3.01 | 2.24 |
| ratio phenolic/epoxy equivalents | 1:1 | 0.8:1 | 1:1 |

TABLE 8

| | Example Number | | |
|---|---|---|---|
| | 12 | 13 | 14 |
| Varnish gel time (seconds) | 202 | 197 | 206 |
| Oven time (minutes) | 4:15 | 5:00 | 4:00 |
| Prepreg resin content (wt %) | 44 | 43 | 40 |
| Prepreg dust gel time (seconds) | 62 | 73 | 67 |
| Tg (heat1/heat2) (° C.) | 182/181 | 151/153 | 192/192 |

### Examples 15 Through 19

The varnish compositions of Examples 15 through 19 were prepared from their components according to Table 9 and the procedures described in Example 4. Methyl Ethyl Ketone (MEK) and cyclohexanone were used in these formulations to improve the solubility of their components, their cold temperature (5.55° C.) resin stability and their prepreg appearance. Physical blends of a tBPN and an OPN, Table 9, were used instead of just the OPN as described in Example 4. Prepregs and laminates were subsequently prepared from these varnishes as described in Example 4 and Table 10.

TABLE 9

| | Example Number | | | | |
|---|---|---|---|---|---|
| | 15 | 16 | 17 | 18 | 19 |
| parts (grams) EPON Resin 164 | 19.15 | 18.12 | 17.24 | 16.32 | 14.79 |
| parts (grams) EPON Resin 1163 | 30.00 | 30.01 | 30.02 | 30.01 | 30.00 |
| parts (grams) OPN | — | 8.07 | 13.89 | 20.08 | 30.21 |
| parts (grams) tBPN | 25.85 | 18.88 | 13.88 | 8.60 | — |
| parts (grams) Acetone | 16.69 | 12.05 | 16.40 | 15.88 | 15.14 |
| parts (grams) MEK | 13.93 | 19.32 | 14.95 | 15.44 | 16.27 |
| parts (grams) Cyclohexanone | 5.61 | 5.60 | 5.60 | 5.60 | 5.60 |
| parts (grams) 10% 2MI/90% PGME | 3.30 | 3.41 | 3.60 | 3.81 | 4.02 |
| ratio phenolic/epoxy equivalents | 1:1 | 1:1 | 1:1 | 1:1 | 1:1 |

TABLE 10

| | Example Number | | | | |
|---|---|---|---|---|---|
| | 15 | 16 | 17 | 18 | 19 |
| Varnish gel time | 197 | 205 | 201 | 196 | 225 |
| (seconds) | | | | | |
| Oven time (minutes) | 3:30 | 3:45 | 3:30 | 3:30 | 4:45 |
| Prepreg resin content | 41 | 41 | 43 | 41 | 44 |
| (wt %) | | | | | |
| Prepreg dust gel time | 72 | 70 | 81 | 87 | 75 |
| (seconds) | | | | | |
| Tg (heat1/heat2) (° C.) | 188/187 | 186/186 | 183/181 | 176/176 | 171/172 |

### Examples 20 Through 22

The varnish compositions of Examples 22 through 22 were prepared from their components according to Table 11 and the procedures described in Example 4. As shown in Table 11, compositions with increasing Weight Average Molecular Weight OPN's were formulated using an identical amount of these varnishes' other components to assess the influence of OPN Mw values upon the prepreg and laminate properties of these compositions. Prepregs and laminates were subsequently prepared from these varnishes as described in Example 4 and Table 12. The quality of the prepreg surface appearance decreased as the Mw value of the OPN increased.

TABLE 11

| | Example Number | | |
|---|---|---|---|
| | 20 | 21 | 22 |
| parts (grams) EPON Resin 828 | 16.68 | 16.70 | 16.73 |
| parts (grams) EPON Resin 1163 | 30.07 | 30.00 | 30.03 |
| parts (grams) OPN | 28.32 | 28.33 | 28.33 |
| OPN Mw | 2690 | 2260 | 1631 |
| parts (grams) Acetone | 11.29 | 11.31 | 11.42 |
| parts (grams) MEK | 15.25 | 15.26 | 15.28 |
| parts (grams) Cyclohexanone | 5.60 | 5.60 | 5.60 |
| parts (grams) 10% 2MI/90% PGME | 3.41 | 3.60 | 4.01 |
| ratio phenolic/epoxy equivalents | 0.8:1 | 0.8:1 | 0.8:1 |

TABLE 12

| | Example Number | | |
|---|---|---|---|
| | 20 | 21 | 22 |
| Varnish gel time (seconds) | 198 | 225 | 192 |
| Oven time (minutes) | 4:15 | 5:00 | 4:15 |
| Prepreg resin content (wt %) | 43 | 42 | 42 |
| Prepreg dust gel time (seconds) | 64 | 61 | 63 |
| Tg (heat1/heat2) (° C.) | 152/151 | 158/157 | 147/147 |

### Examples 23 Through 26

The varnish compositions of Examples 23 through 26 were prepared from their components according to Table 13 and the procedures described in Example 4. Increasing amounts of tertiary-butylphenol (tBP), as indicated in Table 13, were added to these varnishes to examine the effect of residual amounts of this monomer in its novolac upon the properties of the prepreg and laminate made using these materials. Prepregs and laminates were subsequently prepared from these varnishes as described in Example 4 and Table 14. Both varnishes in Example 25 and 26 “smoked” during their Varnish Gel Tests as the tBP boiled off the surface of the gel plate during this test. Also, the quality of the surface appearance of the prepregs became increasingly poorer as the amount of tBP increased due to the increasing presence of small surface bumps on these prepregs.

TABLE 13

| | Example Number | | | |
|---|---|---|---|---|
| | 23 | 24 | 25 | 26 |
| parts (grams) EPON Resin 164 | 15.35 | 15.36 | 15.36 | 15.42 |
| parts (grams) EPON Resin 1163 | 30.00 | 30.02 | 30.00 | 30.00 |
| parts (grams) EPON Resin 828 | 6.57 | 6.63 | 6.61 | 6.63 |
| parts (grams) tBPN | 23.09 | 22.63 | 22.15 | 21.18 |
| parts (grams) tBP | — | 0.47 | 0.92 | 1.84 |
| Wt % tBP in tBP + tBPN | 0.02 | 2.02 | 4.02 | 8.02 |
| parts (grams) Acetone | 19.00 | 19.00 | 18.92 | 20.00 |
| parts (grams) MEK | 12.43 | 12.44 | 12.44 | 11.41 |
| parts (grams) Cyclohexanone | 5.60 | 5.63 | 5.60 | 5.61 |
| parts (grams) 10% 2MI/90% PGME | 3.40 | 3.40 | 3.41 | 4.00 |
| ratio phenolic/epoxy equivalents | 0.8:1 | 0.8:1 | 0.8:1 | 0.8:1 |

TABLE 14

| | Example Number | | | |
|---|---|---|---|---|
| | 23 | 24 | 25 | 26 |
| Varnish gel time (seconds) | 200 | 204 | 198 | 160 |
| Oven time (minutes) | 4:00 | 4:00 | 4:00 | 4:00 |
| Prepreg resin content (wt %) | 40 | 42 | 42 | 40 |
| Prepreg dust gel time (seconds) | 71 | 68 | 64 | 58 |
| Tg (heat1/heat2) (° C.) | 179/180 | 180/179 | 180/181 | 178/178 |

### Examples 27 Through 29

The varnish compositions for Examples 27 through 29 were prepared from their components according to Table 15 and the procedures described in Example 4. In these examples, however, novolacs were utilized that had been prepared from monomeric blends of para-tertiary-butylphenol and para-octylphenol at various compositions ranging from 30 to 70 molar fraction percent octylphenol. The resulting novolac copolymer/blend mixture was used in the formulations of Examples 27 through 29. Their nomenclature is defined in Table 16. Prepregs and laminates were subsequently prepared from these varnishes as described in Example 4 and Table 17.

TABLE 15

| | Example Number | | |
|---|---|---|---|
| | 27 | 28 | 29 |
| parts (grams) EPON Resin 164 | 17.55 | 16.57 | 16.00 |
| parts (grams) EPON Resin 1163 | 30.01 | 30.00 | 30.00 |
| parts (grams) 30_OPN/70_tBPN | 27.46 | — | — |
| parts (grams) 50_OPN/50_tBPN | — | 28.50 | — |
| parts (grams) 70_OPN/30_tBPN | — | — | 29.01 |
| parts (grams) Acetone | 16.74 | 16.08 | 16.24 |
| parts (grams) MEK | 17.77 | 15.34 | 15.64 |
| parts (grams) Cyclohexanone | 5.90 | 5.62 | 5.61 |
| parts (grams) 10% 2MI/90% PGME | 3.75 | 3.76 | 4.00 |
| ratio phenolic/epoxy equivalents | 1:1 | 1:1 | 1:1 |

TABLE 16

Composition
(molar fraction monomer, %)

| Nomenclature | Octylphenol | Tertiary Butylphenol |
|---|---|---|
| 30_OPN/70_tBPN | 30 | 70 |
| 50_OPN/50_tBPN | 50 | 50 |
| 70_OPN/30_tBPN | 70 | 30 |

TABLE 17

| | Example Number | | |
|---|---|---|---|
| | 27 | 28 | 29 |
| Varnish gel time (seconds) | 209 | 210 | 231 |
| Oven time (minutes) | 4:15 | 4:15 | 4:00 |
| Prepreg resin content (wt %) | 43 | 43 | 41 |
| Prepreg dust gel time (seconds) | 73 | 77 | 87 |
| Tg (heat1/heat2) (° C.) | 192/190 | 189/187 | 180/181 |

### Examples 30 Through 34

The varnish compositions for Examples 30 through 34 were prepared from their components according to Table 18 and the procedures described in Example 4. In these compositions, physical blends of EPON Resin 828 and EPON Resin 164 were utilized along with EPON Resin 1163. Prepregs and laminates were subsequently prepared from these varnishes as described in Example 4 and Table 19.

TABLE 18

| | Example Number | | | | |
|---|---|---|---|---|---|
| | 30 | 31 | 32 | 33 | 34 |
| parts (grams) EPON Resin 828 | 16.10 | 13.04 | 10.35 | 6.75 | 4.29 |
| parts (grams) EPON Resin 164 | — | 3.26 | 6.93 | 10.13 | 12.85 |
| parts (grams) EPON Resin 1163 | 30.00 | 30.00 | 30.01 | 30.01 | 30.00 |
| parts (grams) 30_OPN/70_tBPN | 29.01 | 28.71 | 27.76 | 28.11 | 27.88 |
| parts (grams) Acetone | 15.76 | 15.98 | 16.39 | 21.28 | 22.11 |
| parts (grams) MEK | 15.64 | 15.51 | 14.94 | 9.38 | 9.35 |
| parts (grams) Cyclohexanone | 5.74 | 5.61 | 5.63 | 5.64 | 5.71 |
| parts (grams) 10% 2MI/90% PGME | 3.99 | 4.02 | 3.91 | 3.71 | 3.61 |
| ratio phenolic/epoxy equivalents | 1:1 | 1:1 | 1:1 | 1:1 | 1:1 |

TABLE 19

| | Example Number | | | | |
|---|---|---|---|---|---|
| | 30 | 31 | 32 | 33 | 34 |
| Varnish gel time | 224 | 218 | 227 | 233 | 234 |
| (seconds) | | | | | |
| Oven time (minutes) | 4:00 | 4:00 | 4:00 | 4:00 | 4:15 |
| Prepreg resin content | 41 | 42 | 42 | 42 | 42 |
| (wt %) | | | | | |
| Prepreg dust gel time | 86 | 84 | 84 | 90 | 93 |
| (seconds) | | | | | |
| Tg (heat1/heat2) (° C.) | 177/177 | 178/179 | 186/183 | 188/186 | 192/191 |

### Example 35

The varnish composition for Examples 35 was prepared from its components according to Table 20 and the procedures described in Example 4. EPON Resin 58005A80 is a liquid epoxy adducted with 40% carboxylated butadiene-acrylonitrile rubber that is dissolved in acetone at 80 weight percent solids (having a WPE from 325 to 375). EPON Resin 58005 is available from Resolution Performance Products. Prepregs and laminates were subsequently prepared from this varnish as described in Example 4 and Table 21.

### Example 36

The varnish composition for Examples 36 was prepared from its components according to Table 20 and the procedures described in Example 4. SANTOLINK® EP-550 is approximately 71 weight percent solid solution of butyl etherified phenol formaldehyde crosslinker resin that is manufactured by Surface Specialties, Inc. Prepregs and laminates were subsequently prepared from this varnish as described in Example 4 and Table 21.

### Example 37

The varnish composition for Examples 37 was prepared from its components according to Table 20 and the procedures described in Example 4. Tetrabromobisphenol of Acetone (TBBPA, 4,4′-(1 -Methylenthylidene)bis[2,6-dibromo-]phenol)) is a Brominated flame retardant widely employed in the electrical laminating industry. This compound can be obtained from Great Lakes Chemical Corporation as great Lakes BA-59PC. Prepregs and laminates were subsequently prepared from this varnish as described in Example 4 and Table 21.

### Examples 38

The varnish composition for Examples 38 was prepared from its components according to Table 20 and the procedures described in Example 4. Nyatl® 7700 is an industrial grade talc sold by R. T. Vanderbilt Company, Inc. Prepregs and laminates were subsequently prepared from this varnish as described in Example 4 and Table 21.

TABLE 20

| | Example Number | | | |
|---|---|---|---|---|
| | 35 | 36 | 37 | 38 |
| parts (grams) EPON Resin 164 | 16.20 | 6.52 | 21.47 | 9.41 |
| parts (grams) EPON Resin 1163 | 21.00 | 30.00 | — | 21.00 |
| parts (grams) EPON Resin 828 | 3.57 | 9.78 | 14.31 | 14.12 |
| parts (grams) EPON Resin 58005A80 | 23.09 | — | — | — |
| parts (grams) SANTOLINK ® EP-560 | — | 3.76 | — | — |
| parts (grams) TBBPA | — | — | 25.66 | — |
| Parts (grams) 30_OPN/70_tBPN | 28.60 | 26.04 | 13.59 | 30.47 |
| parts (grams) NYTAL ® 7700 | — | — | — | 2.76 |
| parts (grams) Acetone | 14.52 | 16.25 | 21.70 | 14.95 |
| parts (grams) MEK | 15.41 | 14.05 | 7.32 | 16.42 |
| parts (grams) Cyclohexanone | 5.61 | 5.63 | 5.60 | 5.70 |
| parts (grams) 10% 2MI/90% PGME | 3.41 | 3.76 | 2.01 | 3.50 |
| ratio phenolic/epoxy equivalents | 1:1 | 1:1 | 1:1 | 1:1 |

TABLE 21

| | Example Number | | | |
|---|---|---|---|---|
| | 35 | 36 | 37 | 38 |
| Varnish gel time (seconds) | 213 | 225 | 194 | 210 |
| Oven time (minutes) | 4:30 | 4:45 | 3:45 | 4:30 |
| Prepreg resin content (wt %) | 41 | 42 | 43 | 42 |
| Prepreg dust gel time (seconds) | 72 | 74 | 73 | 70 |
| Tg (heat1/heat2) (° C.) | 182/181 | 176/177 | 167/169 | 184/183 |

### Examples 39 Through 42

The varnish composition for Examples 39 through 42 was prepared from their components according to Table 22 and the procedures described in Example 4. Prepregs and laminates were subsequently prepared from this varnish as described in Example 4 (with the exception that the sheets of prepreg were placed between 1 ounce/square foot copper foils and then fully cured in the press) and Table 23. Flammability samples were then prepared from these eight ply 7628 Copper Clad laminates which had their copper foil surfaces removed by acid etching. The Time to Delaminate samples were prepare from the prepreg as described in Table 23 and Example 4 (with the exception that four plies of the 7628 prepreg were placed between the 1 ounce/square foot copper foils and then fully cured in the press).

TABLE 22

| | Example Number | | | |
|---|---|---|---|---|
| | 39 | 40 | 41 | 42 |
| parts (grams) EPON Resin 164 | 41.39 | 37.66 | 33.95 | 30.23 |
| parts (grams) EPON Resin 1163 | 72.00 | 84.00 | 96.02 | 108.02 |
| parts (grams) EPON Resin 828 | 62.00 | 56.47 | 50.96 | 45.37 |
| Parts (grams) 30_OPN/70_tBPN | 124.65 | 121.88 | 119.16 | 116.43 |
| parts (grams) Acetone | 57.54 | 59.74 | 61.21 | 62.69 |
| parts (grams) MEK | 67.83 | 65.63 | 64.21 | 62.80 |
| parts (grams) Cyclohexanone | 22.85 | 22.39 | 22.40 | 22.40 |
| parts (grams) 10% 2MI/90% | 13.60 | 14.00 | 14.41 | 14.90 |
| PGME | | | | |
| ratio phenolic/epoxy equivalents | 1:1 | 1:1 | 1:1 | 1:1 |

TABLE 23

| | Example Number | | | |
|---|---|---|---|---|
| | 39 | 40 | 41 | 42 |
| Varnish gel time (seconds) | 216 | 218 | 219 | 219 |
| Oven time (minutes) | 4:15 | 4:15 | 4:15 | 4:15 |
| Prepreg resin content (wt %) | 42 | 42 | 42 | 43 |
| Prepreg dust gel time (seconds) | 84 | 79 | 83 | 84 |
| Tg (heat1/heat2) (° C.) | 185/185 | 186/191 | 188/186 | 186/185 |
| Total Burn Time (seconds) | 9 | 3 | 1 | 1 |
| Time to Delaminate @ 260° C. | 81 | 70 | 62 | 55 |
| (minutes) | | | | |

While the present invention has been described and illustrated by reference to particular embodiments and examples, those of ordinary skill in the art will appreciate that the invention lends itself to variations not necessarily illustrated herein. For this reason, then, reference should be made solely to the appended claims for purposes of determining the true scope of the present invention.

I claim:

1. An epoxy resin composition comprising an epoxy resin component, an optional solvent component, and a curing agent comprising at least one substituted novolac represented by the formula: 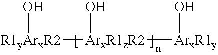
wherein each Ar represents an aryl or cyclo-alkyl group containing x number of carbon atoms, OH represents a hydroxyl group bonded to each Ar group, each R1 represents substituent group(s) bonded to each Ar group and each R1 is an alkyl group or aryl group containing 2 to 20 carbon atoms, each R2 represents a group connecting adjacent Ar groups, n is a number between 2 and 20, x is an integer from 4 to 8, y is an integer from 1 to x-2, and z is an integer from 1 to x-3; and
wherein a cured varnish comprising the epoxy resin composition has a dielectric constant (Dₖ), as determined in accordance with ASTM D150 at 1 MHz, of less than 3.5.

2. The epoxy resin composition of claim 1 wherein the cured varnish has a dissipation factor (Df), as determined in accordance with ASTM D150 at 1 MHz, of less than 0.025.

3. The epoxy resin composition of claim 1 wherein each aryl or cyclo-alkyl group, Ar, contains 5 to 7 carbon atoms and each R2 is an alkyl group containing 1 to 5 carbon atoms

4. The epoxy resin composition of claim 1 wherein each R1 is independently a group selected from the group consisting of butyl, octyl and phenyl and each R2 is alkyl group containing 1 to 5 carbon atoms, and n is a number from 4 and 20.

5. The epoxy resin composition of claim 1 wherein the substituted novolac curing agent is represented by the formula: 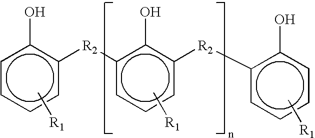
wherein each R1 is a substituent group independently selected from the group consisting of butyl, octyl and phenyl, each R2 is independently a methyl or ethyl group, and n is a number from 4 and 20.

6. The epoxy resin composition of claim 1 wherein the substituted novolac curing agent is represented by the formula: 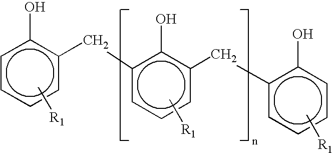
wherein R1 is independently a substituent group selected from the group consisting of butyl, octyl and phenyl and n is a number from 4 and 20.

7. The epoxy resin composition of claim 1 wherein the substituted novolac curing agent is selected from the group consisting of octyl-phenol novolac, nonyl-phenol novolac, phenyl phenol novolac, t-butyl-phenol novolac and combinations thereof.

8. The epoxy resin composition of claim 1 wherein the substituted novolac curing agent comprises two different substituted novolac curing agents selected from the group consisting of octyl-phenol novolac, nonyl-phenol novolac, phenyl phenol novolac and t-butyl-phenol novolac.

9. The epoxy resin composition of claim 8 wherein the two different substituted novolac curing agents are octyl-phenyl novolac and t-butyl-phenol novolac.

10. The epoxy resin composition of claim 1 wherein the substituted novolac curing agent comprises a substituted co-novolac compound wherein R1 represents a different alkyl group on the same molecule.

11. The epoxy resin composition of claim 10 wherein each R1 is an alkyl group, having from 4 to 9 carbon atoms.

12. The epoxy resin composition of claim 10 wherein the substituted co-novolac compound contains octyl and butyl substituent groups.

13. The epoxy resin composition of claim 10 wherein the substituted co-novolac curing agent comprises a blend of t-butyl-phenol novolac and octyl-phenyl novolac ranging from about 10 to about 90 molar fraction percent octyl-phenol novolac.

14. The epoxy resin composition of claim 1 wherein the epoxy resin component comprises an epoxy resin produced from an epihalohydrin and a phenol or a phenol type compound.

15. The epoxy resin composition of claim 14 wherein the epoxy resin component further comprises a halogenated epoxy resin produced from an epihaloydrin and a halogenated phenol or phenol type compound.

16. The epoxy resin composition of claim 1 wherein the epoxy resin component contains a total of epoxy groups, wherein the substituted novolac curing agent contains a total of phenolic hydroxyl equivalents, and wherein a ratio of the total epoxy groups to the phenolic hydroxyl equivalents is between about 0.5 to about 1.5.

17. The epoxy resin composition of claim 16 wherein a ratio of the total epoxy groups to the phenolic hydroxyl equivalents is between about 0.6 to about 1.2.

18. The epoxy resin composition of claim 1 wherein the epoxy resin component comprises a mixture of an epoxy resin and a flame retarded additive and phenolic hydroxyl groups, wherein the flame retarded additive may or may not contain a halogen.

19. The epoxy resin composition of claim 1 wherein the curing agent further comprises a unsubstituted phenol curing agent.

20. A prepreg comprising the epoxy resin composition of claim 1.

21. A method to prepare an epoxy resin composition comprising contacting an epoxy resin component with the substituted novolac curing composition of claim 1.
